(19) United States
(12) Patent Application Publication
(10) Pub. No.: US 2018/0312183 A1
(43) Pub. Date: Nov. 1, 2018

(54) SHEET TRANSPORT DEVICE

(71) Applicant: William Sanford, Mesa, AZ (US)

(72) Inventor: William Sanford, Mesa, AZ (US)

(21) Appl. No.: 15/967,813

(22) Filed: May 1, 2018

Related U.S. Application Data
(60) Provisional application No. 62/492,554, filed on May 1, 2017.

(51) Int. Cl. B62B 1/26; B62B 1/14; B62B 3/10; B62B 5/06

(52) U.S. Cl. CPC B62B 1/268; B62B 5/06; B62B 3/108; B62B 1/147

(57) ABSTRACT

A sheet transport device and method of formation are disclosed. The device may be used to carry and fully support a load, such as one or more sheets of drywall, plywood, or similar materials. The load is supported by a sheet channel coupled to a wheeled axle. One or more braces may be coupled to the sheet channel to form a substantially flat frame, which may or may not also include a handle. The combined weight of the load and the sheet transport device acting on a point of contact between the wheel and a support surface is opposed by an upward force on the wheel creates a torque, causing the handle and/or the frame to rotate against the load, stabilizing the load. A user can easily push and steer the device by grasping and stabilizing the load with one hand.

### CROSS REFERENCE TO RELATED APPLICATION

This application claims priority to U.S. Provisional patent application to William Sanford entitled “SHEET TRANSPORT DEVICE,” Ser. No. 62/492,554, filed May 1, 2017, the disclosures of which are hereby incorporated entirely herein by reference.

### BACKGROUND OF THE INVENTION

### Technical Field

This invention relates to devices to transport building materials. In particular, the invention relates to a sheet transport device for moving sheets of building materials, such as drywall, plywood, and the like.

### State of the Art

Drywall, plywood, and similar sheet building materials are bulky and heavy. Consequently, sheet building materials are awkward for a person to move from place to place, such as at a jobsite. For example, a typical sheet of drywall or plywood measures four (4) by eight (8) feet and may weigh from fifty (50) to eighty-five (85) pounds, depending on its composition and thickness. Because carrying even one sheet of such a large and relatively heavy material by hand is difficult, various handles, carts, and other devices have been created to assist a person in moving sheets of building materials.

All currently available devices to aid a person in moving sheet building materials have both advantages and problems. Handles and harnesses are small, simple devices that reversibly attach to a sheet of material and make carrying the sheet less awkward for the user. Handles and harnesses are generally collapsible and do not take-up significant room, are inexpensive, and lightweight. Handles and harnesses, however, require the user to support the full weight of the sheet being moved, which is physically strenuous and limits transport of more than one or two sheets at a time. Wheeled carriages are multi-wheeled, often large cart-like devices which fully support the weight of building materials, thus enabling a user to move multiple sheets at a time. Existing carriages, however, take up a lot of room and can be difficult for the worker to steer and maneuver, particularly within the often-limited confines of a building interior.

What is needed, therefore, is a conveyance for sheet building materials that fully supports the weight of the building sheet(s), is small, and is easy to steer and operate.

### SUMMARY OF EMBODIMENTS

Disclosed is a sheet transport device comprising an axle having a first end and a second end; a sheet channel coupled to the first end of the axle; a wheel operatively coupled to the second end of the axle, wherein the wheel engages a support surface at a contact point on the wheel; and a brace coupled to the sheet channel, wherein a combined weight of a load on the sheet channel and the sheet transport device generates a first torque about the contact point, and wherein an operator force applied to the load generates a second torque about the contact point substantially a same magnitude as the first torque that opposes the first torque.

In some embodiments, the device further comprises a handle coupled to the sheet channel. In some embodiments, the wheel is removable from the second end of the axle.

In some embodiments, the sheet transport device comprises two axles coupled to the sheet channel, each of the two axles operatively coupled to a wheel, wherein the two contact points of the two wheels are disposed substantially coplanar to each other, and the two axles are disposed substantially parallel to each other. In some embodiments, the device comprises a handle coupled to the sheet channel. In some embodiments, the handle is removably coupled to the sheet channel.

Disclosed is a transport device, comprising an axle having a first end and a second end; a sheet channel coupled to the first end of the axle; a wheel operatively coupled to the second end of the axle, wherein the wheel engages a support surface at a contact point on the wheel; a handle coupled to the sheet channel; and a framework coupled to the handle, wherein a combined weight of a load on the sheet channel and the sheet transport device to create a first torque about the contact point, and wherein an operator force on the load generates a second torque about the contact point substantially a same magnitude as the first torque that opposes the first torque.

In some embodiments, the operator force on the load generates the second torque that opposes the first torque by forcing the load against the handle at a load point to establish the second torque in the opposite direction.

In some embodiments, the framework is coupled to the sheet channel. In some embodiments, the device comprises two axles coupled to the sheet channel, each of the two axles operatively coupled to a wheel, wherein the contact points of the two wheels are disposed substantially coplanar to each other, and the two axles are disposed substantially parallel to each other. In some embodiments, the framework is coupled to the sheet channel.

Disclosed is a method of using a sheet transport device comprising steps placing a load on a sheet channel of a sheet transport device, wherein a combined weight of the load and the sheet transport device offset from a wheel mounted on an axle of the sheet transport device, causing a first torque about the contact point; and opposing the first torque about the contact point by applying an operator force to the load to generate a second torque having substantially a same magnitude as the first torque, wherein the loaded sheet transport device is balanced on the wheel and the first torque and the second torque are in equilibrium.

In some embodiments, the method further comprises transporting the load on the sheet transport device while maintaining torque equilibrium.

The foregoing and other features and advantages of the present invention will be apparent to those of ordinary skill in the art from the following more particular description of the invention and its embodiments, and as illustrated in the accompanying drawing figures.

### BRIEF DESCRIPTION OF THE DRAWINGS

FIG. 1 is a top-front perspective view of a sheet transport device;

FIG. 2 is a top-rear perspective view of a sheet transport device;

FIG. 3 is a side view of a sheet transport device;

FIG. 4 is a top-front perspective view of a sheet transport device bearing a load;

FIG. 5 is a side view of a sheet transport device bearing a load;

FIG. 6 is a top-front perspective view of an alternative embodiment of a sheet transport device;

FIG. 7 is a diagram representing steps of a method of forming a sheet transport device; and

FIG. 8 is a diagram representing steps of a method of using a sheet transport device.

### DETAILED DESCRIPTION OF EMBODIMENTS OF THE INVENTION

Embodiments of the disclosed invention enable a single user to comfortably and safely move large, heavy sheets of a building material without using a conventional bulky, wheeled cart. Additionally, embodiments of the invention eliminate the need for a user to physically carry sheets of the building material, whether unaided or using a removable handle or harness removably coupled to the sheet. When loaded, the sheet transport device is self-aligning with the material to be transported, simplifying single-user operation. The sheet transport device may carry one or more sheets of building material, such as drywall, plywood, and the like, fully supporting the weight of the sheet(s).

Upon loading the device, a sheet of material rests on a sheet channel and against a handle. In some embodiments, one or more supporting braces are coupled to the channel and additionally function to support the sheet. The channel-handle-brace assembly is coupled to one end of an axle with a wheel mounted at the other end. The wheel rests on a support surface, such as a floor or the ground. When loaded, a downward force of the sheet on the channel and the upward force of the support surface on the wheel induces a torque along the axle, causing the handle and braces to rotate against the sheet, firmly contacting the sheet and stabilizing the building material on the device. When loaded, the sheet transport device is so stable that a user can easily push and steer the device by grasping the sheet with one hand, with or without also grasping the handle. The disclosure also includes methods of formation of a sheet transport device.

Throughout this disclosure, the terms “sheet,” “building material,” and “load” are used synonymously, as defined herein below. The terms “sheet transport device,” “transport device,” and “device” are also used synonymously in referring to any or all of the various embodiments of the instant invention.

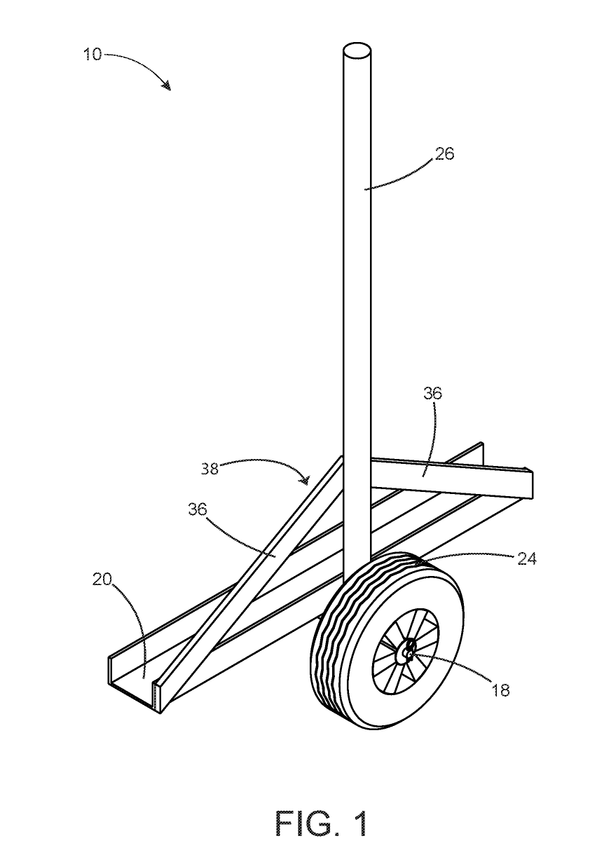

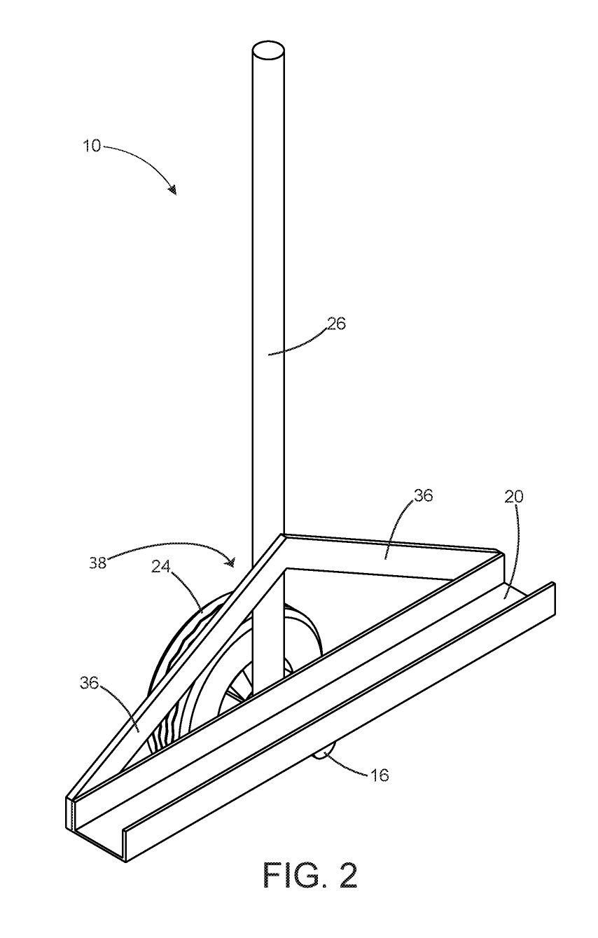

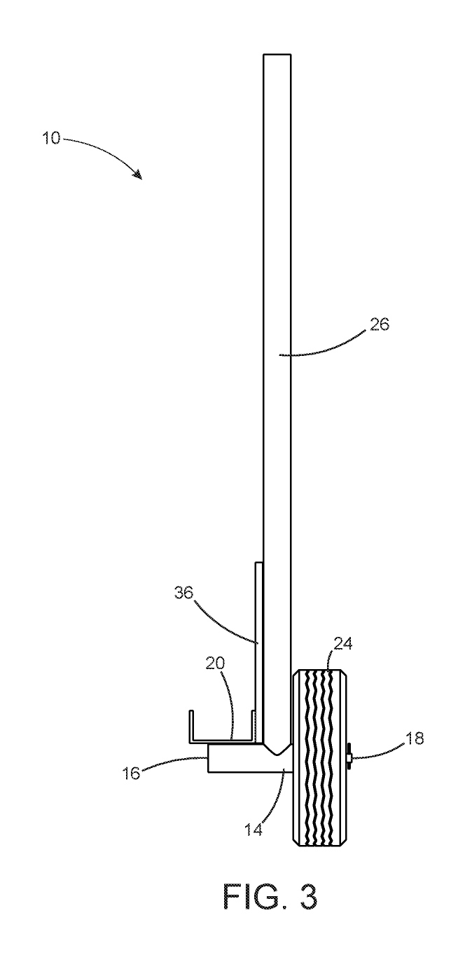

FIG. 1 is a top-front perspective view of a sheet transport device, FIG. 2 is a top-rear perspective view of a sheet transport device, and FIG. 3 is a side view of a sheet transport device. FIGS. 1-3 show a sheet transport device 10 comprising an axle 14 having a first end 16 and a second end 18, a wheel 24, a brace 36, and a sheet channel 20. Sheet channel 20 is coupled to first end 16 and wheel 24 is operatively coupled to second end 18, wherein wheel 24 may rotate on axle 14. In some embodiments, as shown in FIGS. 1-3, a handle 26 is additionally coupled to sheet channel 20 and to brace 36.

In some embodiments, handle 26 is coupled to sheet channel 20. In some embodiments, handle 26 is coupled to brace 36. In some embodiments, handle 26 is removably coupled to brace 36 and sheet channel 20, wherein a user can separate handle 26 from the remainder of sheet transport device 10 to facilitate transport and storage of device 10. In some embodiments, handle 26 is coupled to axle 14. In embodiments of sheet transport device 10 comprising handle 26, a user may grasp handle 26 to support and move unloaded device 10 around a job site. Not all embodiments of device 10 comprise handle 26; in some embodiments, the user moves device 10 around the job site by grasping brace 36. For example, brace 36 may extend a limited length away from axle 14, as shown in the several drawing figures, however brace, in some embodiments, extends a much longer distance away from axle 14 such that the user of device 10 may grasp brace 14 without stooping downward.

Handle 26 is formed from a generally rigid material, such as tubular steel or aluminum; a steel, aluminum, or other metal rod; aluminum; or other suitable material. In some embodiments, handle 26 is formed from a synthetic polymer, such as polyethylene or similar synthetic plastic. In some embodiments, a grip (not shown) is coupled to an end of handle 26 opposite a second end disposed proximate to channel 20, to facilitate the user's firm and comfortable non-slip grip on handle 26. In some embodiments, handle 26 is a single unitary member. In some embodiments, handle 26 comprises a plurality of members removably coupled together, such as telescoping members which may be uncoupled or collapsed, facilitating transport and storage of sheet transport device 10.

In the embodiments shown in the drawing figures, wheel 24 comprises a rubber tire mounted on a metal wheel, such as wheel 24 shown in FIG. 1 and FIG. 2, for example. This is not meant to be limiting. Wheel 24 is formed from any suitable material, including natural and synthetic rubbers, metals and metal alloys, synthetic polymers such as polyethylene and other synthetic plastics, and the like. Wheel 24 is operatively coupled to axle 14 by a coupling member (not shown) wherein wheel 24 rotates on axle 14. The coupling member may comprise a bushing, a bearing cage, free bearings, or other suitable mechanism rotatably coupling a wheel to an axle known to those with skill in the mechanical arts. In some embodiments, wheel 24 is removably coupled to sheet transport device 10 to allow removal of wheel 24 from axle 14, thus facilitating transport and storage of sheet transport device 10.

In some embodiments, sheet transport device 100 comprises one wheel 102. In some embodiments, device 100 comprises two wheels 102. In some embodiments, transport device comprises a plurality of wheels 102. In some embodiments, two wheels 102 are mounted side-by-side on axle 103. In some embodiments, two wheels 102 are mounted each on a separate axle 103, wherein the two wheels 102 are substantially coplanar and the two axles 103 are substantially parallel.

Although multiple configurations of wheels 24 are within the scope of this disclosure, it is advantageous to form sheet transport device 10 with only one wheel 24. A working prototype embodiment of transport device 10 having a single wheel 24 is easier to steer than an embodiment having two or more coplanar wheels. This is because a single wheel may be pivoted on a point. An embodiment having two or more coplanar wheels, however, must be turned along an arc. The steering and operation of a loaded sheet transport device 10 is discussed in greater detail herein below.

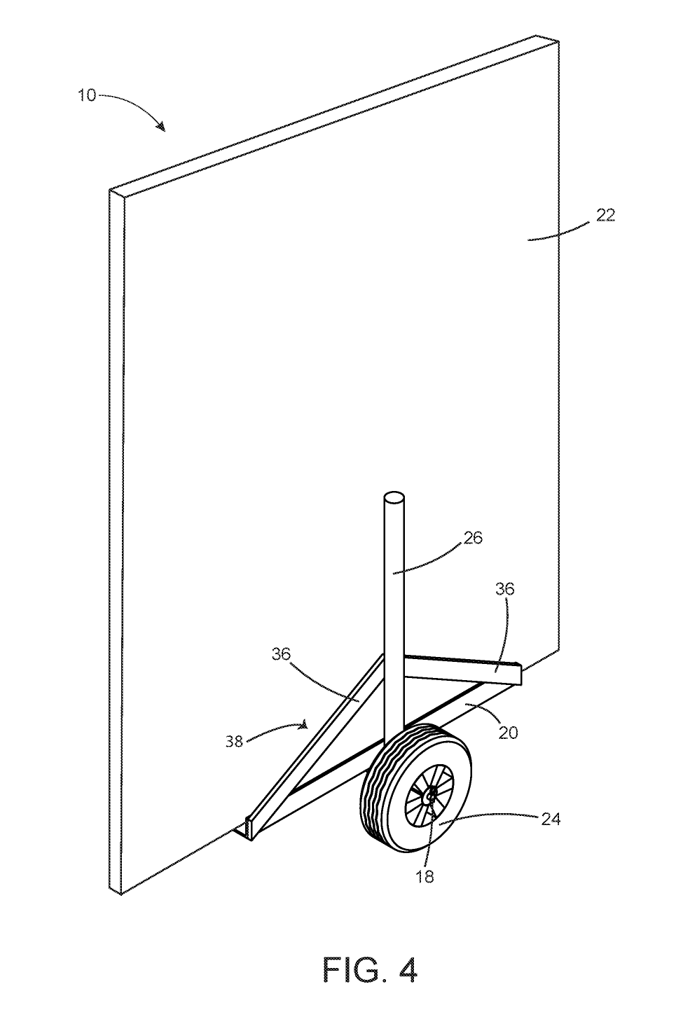

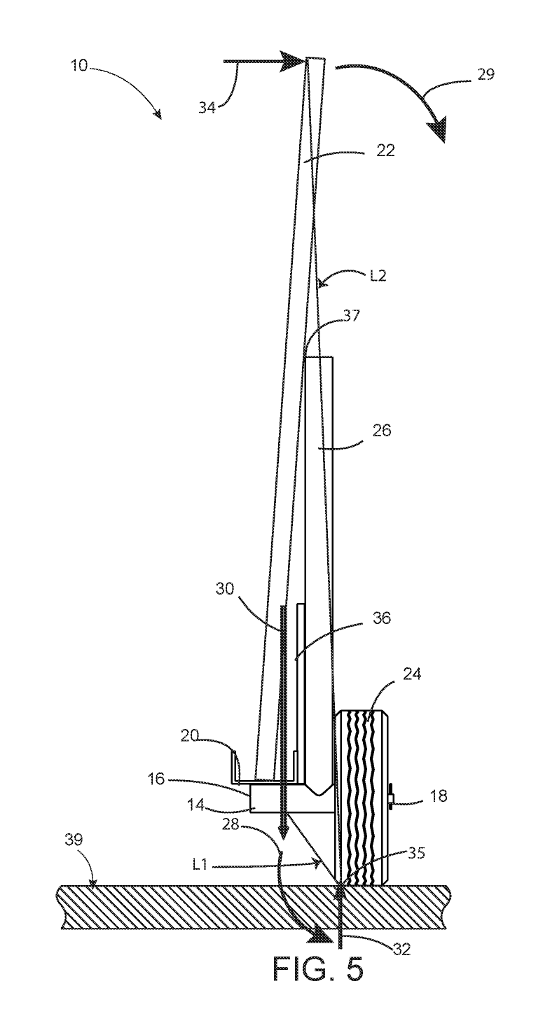

FIG. 4 is a top-front perspective view of a sheet transport device bearing a load. FIG. 5 is a side view of a sheet transport device bearing a load. FIG. 4 and FIG. 5 show sheet transport device 10 in a loaded configuration bearing a load 22, represented by a sheet of a building material. Sheet channel 20 receives an edge of load 22 comprising at least one sheet or the like to be moved, and may partially or fully support the weight of load 22. Load 22 may comprise at least one sheet of a building material, such as drywall, plywood, masonry board, and the like. In some embodiments, sheet channel 20 has a lip, a channel, or a lip and a channel, similar to the embodiment shown in FIG. 1 and FIG. 2. The lip acts to stabilize load 22 resting in channel 20, creating resistance to prevent load 22 from sliding sideways off from channel 20 when sheet transport device 10 is in use. Some embodiments of transport device 10 additionally comprise a channel attachment (not shown) that removably couples to sheet channel 20, such as with a clip or an interlocking surface feature. The channel attachment may be a wider channel, such that channel 20 coupled to the channel attachment enables transport device to carry a wider load 22, such as a 2-inch wide door, for example. Sheet channel 20 is formed from the same material as brace 36, in some embodiments. In some embodiments, sheet channel 20 is formed from a material other than the material forming brace 36. In some embodiments, sheet channel 20 and brace 36 are formed together as a unitary body. In some embodiments, sheet channel 20 and brace 36 are formed separately and coupled together after formation, such as by welding, riveting, annealing, gluing, or other conventionally available and satisfactory coupling method known in the art. In some embodiments, sheet channel 20 and the channel attachment are covered with a non-mar material, such as a rubber, a strip of thick woven fabric, and the like. Such a covering may function to protect an edge of the sheet of load 22 from damage during use of transport device 10.

Brace 36 provides support and rigidity to sheet channel 20. Additionally, brace 36 supports a component of the weight of load 22 under a condition wherein sheet channel 20 is not parallel with a substantially level support surface 39, such as a floor or the ground. In the embodiment shown in the drawing figures, transport device 10 comprises two braces 36, wherein each brace 36 is coupled to sheet channel 20 and handle 26. This configuration is not, however, meant to be limiting. The scope of the disclosed invention is intended to include any plurality of braces 36 coupled to channel 20 and handle 26, in some embodiments, to create a framework 38 of brace members wherein framework 38 is coupled to sheet channel 20 and handle 26, in embodiments of sheet transport device 10 comprising handle 26, which, in some embodiments, is substantially flat to contact and partially support a broad, flat surface of a load 22, such as a sheet of drywall or plywood.

In some embodiments, the framework 38 is comprised of a plurality of braces 36 extending from a range of between about several inches to about several feet above wheel 24. Moreover, some embodiments of sheet transport device 10 comprise handle 26 and some do not. In embodiments comprising handle 26, at least one brace 36 is coupled to handle 26, wherein handle 26 provides additional rigidity and support to the framework. This added rigidity and support is advantageous when transporting heavy loads 22, such as multiple sheets of the building material or a single sheet of very heavy building material. The coupling arrangement of braces 36 coupled to sheet channel 20 may be triangular, such as the embodiment shown in the figures and in some other embodiments. In some embodiments, the coupling arrangement of braces 36 and sheet channel 20 may otherwise be rectangular, polygonal, ellipsoid, or any other shape, without limitation.

FIG. 5 is a side view of a loaded sheet transport device 10. Load 22, as in the embodiment shown in FIG. 5 and some other embodiments, is a sheet of building material that has been removably placed on sheet channel 20. The combined weight of load 22 and sheet transport device 10 causes a downward force 30 on wheel 30 at contact point 25. Additionally, a support surface 39, which is the surface upon which sheet transport device rests, results in an upward force 32 applied to the wheel 24 from the ground surface 39. Downward force 30 induces a first torque 28 about contact point 35 due to the off-center location of the brace 36 and handle 26 with respect to the wheel 24, causing brace 36 and handle 26 to rotate in a direction toward the load 22 side of the sheet transport device 10, thereby also causing load 22, brace 36 and handle 26 to rotate in a direction toward a load side of the transport device 10 in response to first torque 28. An operator force 34 is applied by the user of sheet transport device 10 to load 22 to oppose first torque 28, wherein operator force 34 is applied to load 22 against brace 36 and/or handle 26. Moreover, operator force 34 is of the magnitude to create equilibrium with first torque 28 by generating second torque 29 having the substantially the same magnitude in an opposing direction from first torque 28, thereby stabilizing loaded sheet transport device 10 in a generally upright position with wheel 24 resting on support surface 24. This may generally happen with the operator force 34 being significantly less than the downward force 30 applied by the combined weight of load 22 and sheet transport device 10. This is accomplished because lever arm L1 of downward force 30 is significantly shorter than lever arm L2 of operator force 34, such that the magnitude of the first torque 28 calculated as downward force 30 multiplied by the lever arm length L1 is substantially the same as the operator force 34 multiplied by the lever arm length L2.

The torque equilibrium between first torque 28 and second torque 29 simplifies moving, steering, and handling loaded sheet transport device 10. First torque 28 enables a user of sheet transport device 10 to support, push, pull, and steer sheet transport device 10 bearing load 22, such as a building material sheet, or multiple sheets, by grasping an edge of load 22 with one hand without touching handle 26, brace 36, or any other element of sheet transport device 10. First torque 28 causes brace 36 and handle 26, in embodiments having handle 26, to firmly contact a broad, flat surface of the load 22, which is stabilized by operator force 34 generating second torque 29.

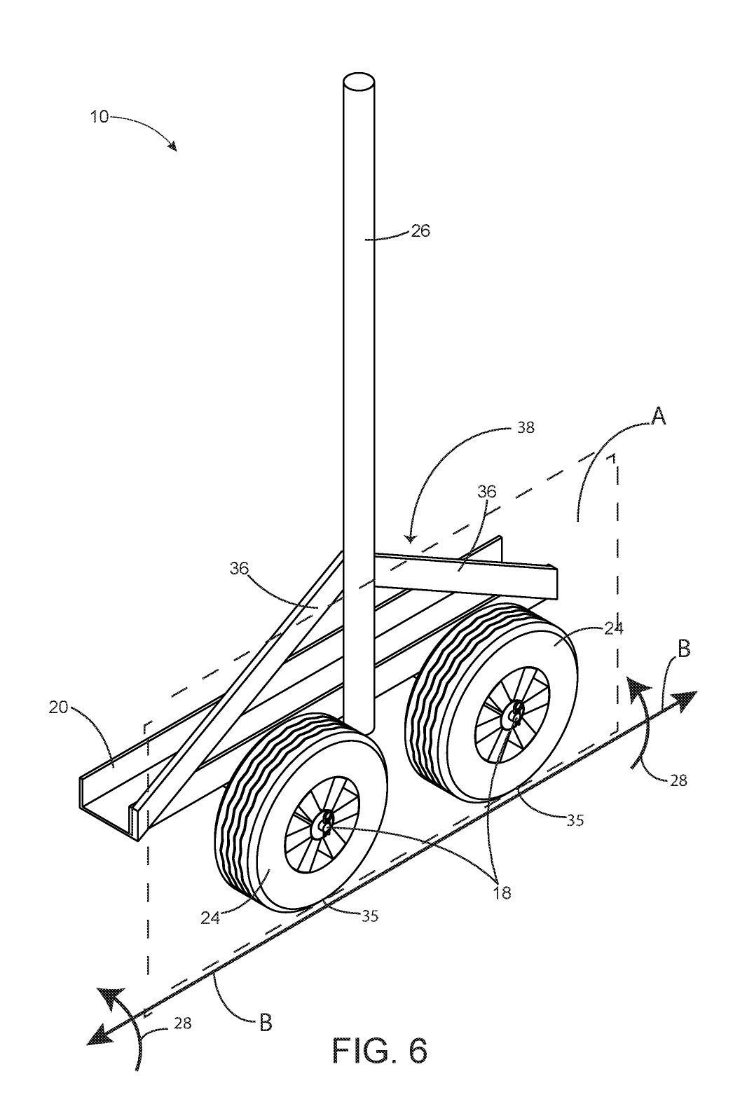

As shown by FIG. 5 and FIG. 6, first torque 28 and acts about contact point 35 along an axis of rotation B (shown by FIG. 6). Note that axis B is generally orthogonal to the rotational axis(s) of wheel(s) 24 on axle(s) 14. Operator force 34 is applied at a considerably farther distance or lever arm L2 from contact point 35 than the distance or lever arm L1 of downward force 30, because a center of mass of loaded sheet transport device 10 (not shown) is much closer to contact point 35 (lever arm L1) than operator force 34 (lever arm L2). Operator force 34, therefore, acts on a substantially longer lever arm L2 than lever arm L1 of downward force 30, wherein a user operating sheet transport device 10 need only apply operator force 34 of minimal magnitude to maintain torque equilibrium about axis B. Also, operator force 34 is transmitted to sheet transport device 10 at a load point 37 or load points 37 where load 22 contacts handle 26, brace 36, or handle 26 and brace 36. In this manner, load 22 is stabilized on sheet transport device 10 by friction at these load points 37. Load 22, therefore, resists falling off device 10 when device 10 with load 22 are rolled by the user holding only the load 22. Conversely, if the user holds only handle 26 or brace 36, but not the load 22, load 22 is unsecured and may become dislodged, particularly if transport device 10 is brought substantially upright or tilted in a direction away from handle 26 or brace 36.

FIG. 6 is a top-front perspective view of an alternative embodiment of a sheet transport device. FIG. 6 shows sheet transport device 10 comprising two wheels 24 and two contact points 35. In some embodiments, sheet transport device 10 comprises one wheel 24. In some embodiments, device 10 comprises a plurality of wheels 24, a plurality of contact points 35, and a plurality of axles 14, as shown in FIG. 6. In some embodiments, a plurality of wheels 24 are mounted each on separate axles 14, such that the plurality of contact points 35 are substantially coplanar with each other, represented by a plane A in FIG. 6, and the plurality of axles 14 are substantially parallel to each other. Regarding contact point 35 or a plurality of coplanar contact points 35, it will be appreciated that contact point 35 is dynamically located on wheel 24 as transport device 10 is rolled along support surface 39. It should also be appreciated that contact point 35 may be along an outer edge or wheel 24, an inner edge or wheel 34, or at any point along a tread-surface of wheel 24, depending on a rotational position of device 10 on axis B; i.e., tilted inward, tilted outward, or substantially upright.

The above discussion notwithstanding, various components defining any sheet transport device may be formed of any of many different types of materials or combinations thereof that can readily be formed into shaped objects provided that the components selected are consistent with the intended operation of a sheet transport device. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any sheet transport device may be purchased pre-manufactured or manufactured separately and then assembled together. However, any or all the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

A sheet transport device has been disclosed. Different embodiments of the sheet transport device allow a user many options for moving bulky materials, such as sheets of building material, including plywood, drywall, masonry board, and the like. The loaded sheet transport device uses a torque arising from the load coupled to an axle to stabilize the load against a frame. The weight of the load acts at a point on the axle offset from a wheel coupled to the axle at an end opposite the load, creating the torque. The torque enables a user of the sheet transport device to more easily move and steer the loaded device using one hand placed on the building material sheet without touching the device itself, wherein the risk of the building material sheet falling off the device is eliminated or greatly reduced.

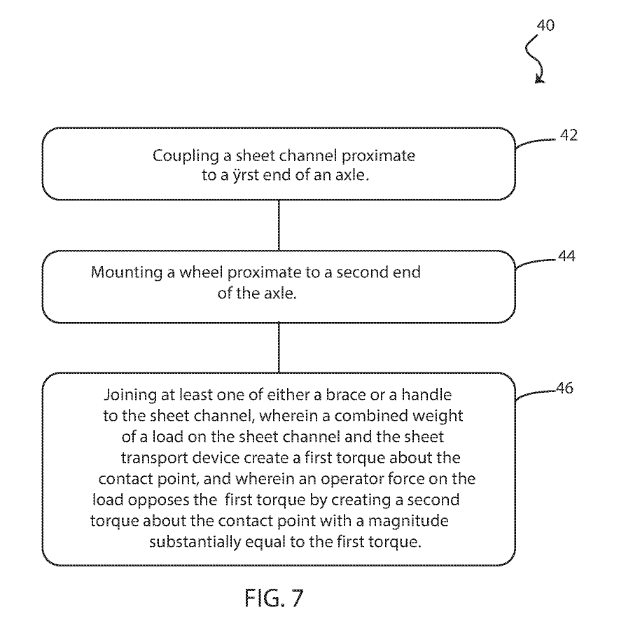

FIG. 7 is a block diagram of a method of forming a sheet transport device. As shown in FIG. 7, a method 40 comprises a coupling step 42, a mounting step 44, and a joining step 46.

Coupling step 42 comprises coupling a sheet channel proximate to a first end of an axle. The sheet channel is a structure configured to receive a sheet of a building material, such as plywood, drywall, and the like. In some embodiments, the sheet channel is coupled to the axle at the first end. In some embodiments, coupling step 44 comprises coupling the sheet channel to a plurality of first ends of a plurality of axles, wherein the axles are disposed substantially parallel to each other. In some embodiments, the plurality of axles is two axles. This is not meant to be limiting, however; in some embodiments, the plurality of axles is greater than two axles.

Mounting step 44 comprises mounting a wheel proximate to the second end of the axle. Mounting step 44 is performed by any suitable coupling means known in the art for operatively coupling a wheel to an axle. In some embodiments, mounting step 44 comprises coupling a plurality of wheels proximate to a plurality of second ends of a plurality of axles. In some embodiments, the plurality of axles is two axles. Wherein two or more wheels are mounted to two or more axles respectively, the wheels are disposed substantially coplanar with respect to one another.

Joining step 46 comprises joining at least one of either a brace or a handle to the sheet channel, wherein a combined weight of a load on the sheet channel and the sheet transport device create a first torque about the contact point, and wherein an operator force on the load opposes the first torque by creating a second torque about the contact point with a magnitude substantially equal to the first torque.

In some embodiments, joining step 46 further comprises joining both the brace and the handle to the sheet channel. In some embodiments, method 40 further comprises a step coupling the handle to the brace. In some embodiments, the brace is coupled to the sheet channel and the handle. In some other embodiments, the brace is only coupled to the handle, but not the sheet channel. For example, the brace may be a plurality of braces joined as a framework and coupled to the handle some distance removed from the sheet channel. In some embodiment, the framework is coupled to the handle greater than about twelve (12) inches from the sheet channel.

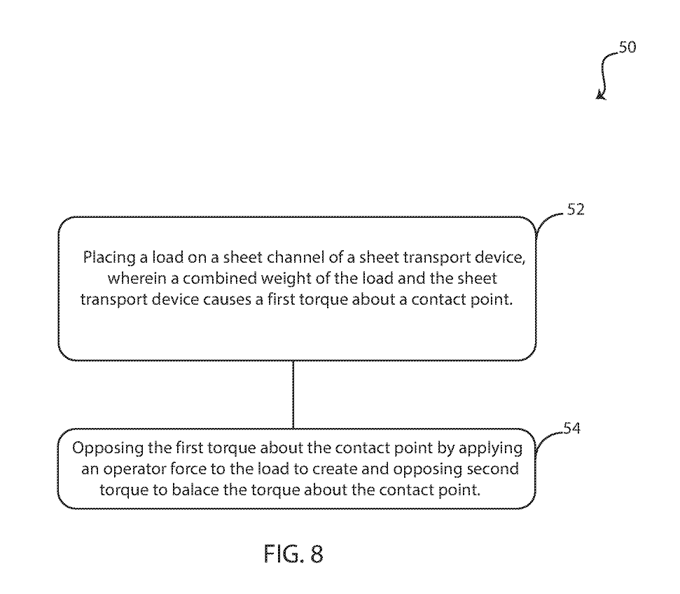

FIG. 8 is a block diagram of a method of using a sheet transport device. FIG. 8 shows a method 50 of using a sheet transport device comprising a loading step 52 and a balancing step 54.

Loading step 52, in some embodiments, comprises placing a load onto a sheet channel of a sheet transport device, wherein a combined weight of the load and the sheet transport device causes a first torque about a contact point. In some embodiments, the load is a sheet of material. In some embodiments, the load is a sheet of a building material, such as sheetrock, plywood, or the like.

Balancing step 54, in some embodiments comprises opposing the first torque about the contact point by applying an operator force to the load to create an opposing second torque of substantially the same magnitude to balance the torque about the contact point. “Balanced” means equilibrium of torques about an axis of rotation passing through the contact point, or, in use of a sheet transport device having two or more wheels, through two or more contact points of the two or more wheels. Balancing step 54 includes, in some embodiments, the user adjusting a magnitude of the operating force wherein the equilibrium of torques is substantially maintained. It is to be noted that the axis of rotation defined by the torques is different than and generally orthogonal to an axis of rotation of the wheel(s) on the axle(s).

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A sheet transport device comprising:
an axle having a first end and a second end;
a sheet channel coupled to the first end of the axle;
a wheel operatively coupled to the second end of the axle, wherein the wheel engages a support surface at a contact point on the wheel; and
a brace coupled to the sheet channel, wherein a combined weight of a load on the sheet channel and the sheet transport device generates a first torque about the contact point, and wherein an operator force applied to the load generates a second torque about the contact point substantially a same magnitude as the first torque that opposes the first torque.

2. The sheet transport device of claim 1, further comprising a handle coupled to the sheet channel.

3. The sheet transport device of claim 1, wherein the wheel is removable from the second end of the axle.

4. The sheet transport device of claim 1, comprising:
two axles coupled to the sheet channel, each of the two axles operatively coupled to a wheel, wherein the two contact points of the two wheels are disposed substantially coplanar to each other, and the two axles are disposed substantially parallel to each other.

5. The sheet transport device of claim 4, further comprising a handle coupled to the sheet channel.

6. The sheet transport device of claim 5, wherein the handle is removably coupled to the sheet channel.

7. A sheet transport device, comprising:
an axle having a first end and a second end;
a sheet channel coupled to the first end of the axle;
a wheel operatively coupled to the second end of the axle, wherein the wheel engages a support surface at a contact point on the wheel;
a handle coupled to the sheet channel; and
a framework coupled to the handle, wherein a combined weight of a load on the sheet channel and the sheet transport device to create a first torque about the contact point, and wherein an operator force on the load generates a second torque about the contact point substantially a same magnitude as the first torque that opposes the first torque.

8. The sheet transport device of claim 7, wherein the operator force on the load generates the second torque that opposes the first torque by forcing the load against the handle at a load point to establish the second torque in the opposite direction.

9. The sheet transport device of claim 7, wherein the framework is coupled to the sheet channel.

10. The sheet transport device of claim 7, comprising two axles coupled to the sheet channel, each of the two axles operatively coupled to a wheel, wherein the contact points of the two wheels are disposed substantially coplanar to each other, and the two axles are disposed substantially parallel to each other.

11. The sheet transport device of claim 7, wherein the framework is coupled to the sheet channel.

12. A method of using a sheet transport device comprising steps:
placing a load on a sheet channel of a sheet transport device, wherein a combined weight of the load and the sheet transport device offset from a wheel mounted on an axle of the sheet transport device, causing a first torque about the contact point; and
opposing the first torque about the contact point by applying an operator force to the load to generate a second torque having substantially a same magnitude as the first torque, wherein the loaded sheet transport device is balanced on the wheel and the first torque and the second torque are in equilibrium.

13. The method of claim 12, further comprising transporting the load on the sheet transport device while maintaining torque equilibrium.
